(19) United States
(12) Patent Application Publication
(10) Pub. No.: US 2013/0115386 A1
(43) Pub. Date: May 9, 2013

(54) MULTI-FUNCTIONAL LABEL STICKER

(71) Applicants: Yao-Kai KUO, Taipei (TW); Yung-Hui HUNG, Taipei (TW); Cheng-Pi LEE, Taipei (TW)

(72) Inventors: Yao-Kai KUO, Taipei (TW); Yung-Hui HUNG, Taipei (TW); Cheng-Pi LEE, Taipei (TW)

(73) Assignee: CMC MAGNETICS CORPORATION, Taipei (TW)

(21) Appl. No.: 13/617,102

(22) Filed: Sep. 14, 2012

(30) Foreign Application Priority Data
Nov. 4, 2011 (TW) 100140224

(51) Int. Cl. B41M 5/50; B41M 5/40

(52) U.S. Cl. 428/32.18; 428/32.22; 428/32.21; 428/32.39

(57) ABSTRACT

The invention relates to a multi-functional label sticker, particularly to a sticker suitable to be marked by means of laser induction process, thermal induction process or ink-jet process, and suitable to be used on any object to be labeled. The sticker comprises a substrate, an adhesion layer formed on a side of the substrate, a release paper attached to a side of the adhesion layer opposite to the substrate, a laser induction ink layer provided on the other side of the substrate, an ink-jet layer or thermal induction ink layer provided on the laser induction ink layer opposite to the substrate. Thus, the sticker of the invention can be marked by at least two different marking means, i.e., laser induction and thermal induction manner, or laser induction and ink-jet coating manner.

### BACKGROUND OF THE INVENTION

1. Field of the Invention

The invention relates to a sticker for multi-functional, marking, and particularly, to a sticker suitable to be marked by means of laser induction process, thermal induction process or ink-jet process, and suitable to be used on any object to be labeled.

2. Description of Related Art

Generally speaking, when using an object, a sticker would be provided on said object for the user to realize the contents, the constituent thereof and etc. The words or patterns could be shown on the sticker as desired through hand writing, machine printing and etc. In general, the manner to provide a sticker on the object is usually to attach the sticker on the object to be labeled by using an adhesive layer.

Taking a slide for example, when an educational organization performs a microorganism observation or a medical institute does the histopathology examination, they all need to use microscope for the above-mentioned operation. For conducting the operation, the microorganism to be observed or the histopathology is first placed on a slide and then a cover glass is placed on the object to be observed for observation. However, since there is a plurality of objects to be observed during the observation, thus it is important to mark on the slide for the observer to clearly understand what is on the slide.

In addition to directly write on the slide with an oil-base pen, conventional manner to mark on the slide is attaching a sticker to the slide, wherein the sticker is marked with words or patterns. Although it is convenient to write by means of an oil-based pen, the words (or writing) may be hard to identify due to the writer's sloppy writing or falling off of the writing because of friction. Therefore, the manner to attach a sticker is more common.

As far as the inventor knows, Leica Microsystems GmbH and Thermal Tags & Labels Company sell the aforesaid sticker for labeling. Please refer to the following website, respectively:

http://www.leica-microsystems.com/products/total-histology/consum ables/slides-coverglass/: and

http://www.thermaltagsandlabels.com/best-sellers-cognitive-lab-slide -label.html

However, although the stickers for labeling disclosed in the above-mentioned website can be marked by machine, it can only adapt to one single marking manner, e.g. ink-jet process or induced thermal transfer process. Hence, the stickers disclosed in the aforesaid website cannot adapt to the marking machines with different marking manners.

Since markings by ink-jet process and induced thermal transfer process are more stable, the users generally use marking machines which can perform ink-jet process or thermal induced transfer process. However, in professional testing institutes, they have not only one kind of marking machine with one specific marking manner, but have even more than two kinds of marking machines with different marking manners. Hence, the aforesaid sticker only adapted to one specific marking machine cannot he used in other marking machines with different marking manners so that the sticker must be used in the specific marking machine, which is not convenient to the users when in use. Therefore, how to provide a sticker adapted to different marking manners is the main purpose which the invention is willing to achieve.

### SUMMARY OF THE INVENTION

The main purpose of the invention is to provide a sticker suitable to be marked by means of laser induction process, thermal induction process or ink-jet process and suitable to be used on any object to be labeled.

The invention utilizes the following technical means in order to achieve the aforesaid inventive purpose, wherein the multi-functional label sticker has following structures:
a substrate;
an adhesion layer formed on a side of the substrate;
a release paper attached to a side of the adhesion layer opposite to the substrate;
a laser induction ink layer disposed on the other side of the substrate;
an ink-jet layer or thermal induction ink layer disposed on a side of the laser induction ink layer opposite to the substrate.

Preferably, a ground color layer is provided between the laser induction ink layer and the substrate.

The substrate could be a paper, plastic membrane, resin membrane or any substrate used to create a sticker.

By the aforesaid structures of the invention, the sticker could be adapted to at least two marking manners. In addition to laser induction marking with a laser induction ink layer, the user could even perform a thermal marking via a thermal induction ink layer, or an ink-jet marking via an ink-jet layer. Therefore, the sticker of the invention could be adapted to at least two marking manners including laser induction marking and thermal induction marking or ink-jet marking to perform marking. When using the sticker of the invention, the sticker is attached to the object to be labeled via the adhesion layer after removing the release paper from the marked label sticker. Hence, the sticker of the invention could he adapted to various marking machines with different marking manners to achieve the purpose of multi-functional marking.

### BRIEF DESCRIPTION OF THE DRAWINGS

FIG. 1 is a side view in accordance with the invention;

FIG. 2 is a perspective view of a first use state in accordance with the invention; and

FIG. 3 is a perspective view of a second use state in accordance with the invention.

### DETAILED DESCRIPTION OF THE INVENTION

Preferred embodiments of the invention with accompanying figures are described in detail as follows.

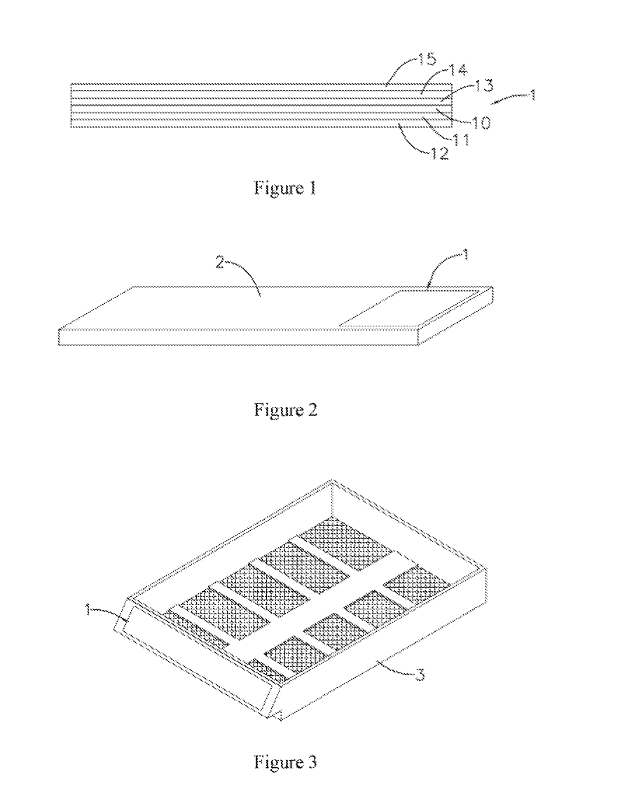

As shown in FIG. 1, the embodiment of multi-functional label sticker 1 of the invention comprises:
a substrate 10;
art adhesion layer 11 formed on a side of the substrate 10;
a release paper 12 attached to a side of the adhesion layer 11 opposite to the substrate 10;
a laser induction ink layer 14 disposed on the other side of the substrate 10;
an ink-jet layer or thermal induction ink layer 15 disposed on a side of the laser induction ink layer 14 opposite to the substrate 10,
wherein a ground color layer 13 is provided between the laser induction ink layer 14 and the substrate 10.

The substrate 10 is selected from one of the following material: paper, plastic membrane and resin membrane.

The aforesaid laser induction ink layer 14 and ink-jet layer or thermal induction ink layer 15 are respectively formed on the substrate 10 by means of screen printing method. Besides, each of layers 14, 15 mentioned above may be formed on the substrate 10 by means of various conventional coating methods.

Preferably, the thickness of the laser induction ink layer 14 and ink-jet layer or thermal induction ink layer 15 is between 5 micrometers and 30 micrometers. If the thickness is less than 5 micrometers, the mark depth may be too shallow to identify. If the thickness is more than 30 micrometers, it may cause the problem that the sum of the thickness of the ink layers is so thick that the ink of the sticker 1 may easily fall off due to collision. Additionally, the thickness of the ground color layer 13 is less than 20 micrometers.

More preferably, the thickness of the laser induction ink layer 14 is less than 8 micrometers and the thickness of the ink-jet layer or thermal induction ink layer 15 is less than 12 micrometers.

The laser induction ink layer 14 of the invention can he irradiated by laser light so that a surface reaction occurs on the laser induction ink layer 14, causing a change of microstructure thereon and thereby changing the appearance of the layer to achieve the purpose of marking.

When marking on the ink-jet layer or thermal induction ink layer 15 of the invention, the ink-jet layer or thermal induction ink layer 15 is coated by ink jetting or thermal induction process to show the marked print, thus achieving the purpose of marking. Besides, the ink-jet layer or thermal induction ink layer 15 can be further used as a protective layer for the laser induction ink layer 14.

Since the invention has the structure mentioned above, it can be adapted to at least two kinds of marking machines with different marking manners via different ink layers of the sticker 1. When using the invention, after placing the sticker 1 onto a marking machine (not shown) to perform a marking process, then removing the release paper 12 from the marked sticker 1 and attaching the adhesion layer 11 of the sticker 1 of the invention to the object to be labeled. FIG. 2 shows the perspective view of the use state in accordance with the stick 1 of the invention used on a slide 2. FIG. 3 shows the perspective view of the use state of the stick 1 according to the invention used on a cargo box 3.

The invention utilizes different ink layers which can be adapted to different kinds of marking machines with different marking manners, which is different from the existing label sticker which can be adapted to only one single marking machine with a specific marking manner. Hence, the label sticker of the invention is quite convenient for users without preparing dedicated label sticker for a marking machine with a specific marking manner.

1. A multi-functional label sticker, comprising
a substrate;
an adhesion layer formed on a side of the substrate;
a release paper attached to a side of the adhesion layer opposite to the substrate;
a laser induction ink layer disposed on the other side of the substrate;
an ink-jet layer or thermal induction ink layer disposed on a side of the laser induction ink layer opposite to the substrate.

2. The multi-functional label sticker according to claim 1, wherein a ground color layer is provided between the laser induction ink layer and the substrate.

3. The multi-functional label sticker according to claim 2, wherein the thickness of the ground color layer is less than 20 micrometers.

4. The multi-functional label sticker according to claim 1, wherein the substrate is selected from one of the following material: paper, plastic membrane and resin membrane.

5. The multi-functional label sticker according to claim 1, wherein the thickness of the laser induction ink layer and ink-jet layer or thermal induction ink layer is between 5 micrometers and 30 micrometers.

6. The multi-functional label sticker according to claim 2, wherein the substrate is selected from one of the following material: paper, plastic membrane and resin membrane.

7. The multi-functional label sticker according to claim 3, wherein the substrate is selected from one of the following material: paper, plastic membrane and resin membrane.
